(19) United States
(12) Patent Application Publication
(10) Pub. No.: US 2016/0088083 A1
(43) Pub. Date: Mar. 24, 2016

(54) PERFORMANCE MONITORING AND TROUBLESHOOTING IN A STORAGE AREA NETWORK ENVIRONMENT

(71) Applicant: CISCO TECHNOLOGY, INC., San Jose, CA (US)

(72) Inventors: Harsha Bharadwaj, BANGALORE (IN); Prabesh Babu Nanjundaiah, TUMKUR (IN)

(73) Assignee: CISCO TECHNOLOGY, INC., San Jose, CA (US)

(21) Appl. No.: 14/492,036

(22) Filed: Sep. 21, 2014

(51) Int. Cl. H04L 29/08; H04L 12/26

(52) U.S. Cl. CPC H04L 67/1097; H04L 43/0852

(57) ABSTRACT

An example method for performance monitoring and troubleshooting in a storage area network (SAN) environment is provided and includes receiving, at a network element in the SAN, a plurality of frames of an exchange between an initiator and a target in the SAN, identifying a beginning frame and an ending frame of the exchange in the plurality of frames, copying the beginning frame and an ending frame of the exchange to a network processor in the network element, extracting, by the network processor, values of a portion of fields in respective headers of the beginning frame and the ending frame, and calculating, by the network processor, a normalized exchange completion time (ECT) based on the values.

### TECHNICAL FIELD

This disclosure relates in general to the field of communications and, more particularly, to performance monitoring and troubleshooting in a storage area network (SAN) environment.

### BACKGROUND

A SAN transfers data between computer systems and storage elements through a specialized high-speed Fibre Channel network. The SAN consists of a communication infrastructure, which provides physical connections. It also includes a management layer, which organizes the connections, storage elements, and computer systems so that data transfer is secure and robust. The SAN allows any-to-any connections across the network by using interconnect elements such as switches. The SAN introduces the flexibility of networking to enable one server or many heterogeneous servers to share a common storage utility. The SAN might include many storage devices, including disks, tapes, and optical storage. Additionally, the storage utility might be located far from the servers that use it.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for performance monitoring and troubleshooting in a storage area network environment;

FIG. 2 is a simplified block diagram illustrating example details of embodiments of the communication system;

FIG. 3 is a simplified block diagram illustrating other example details of embodiments of the communication system;

FIG. 4 is a simplified block diagram illustrating yet other example details of embodiments of the communication system; and

FIG. 5 is a simplified flow diagram illustrating other example operations that may be associated with an embodiment of the communication system.

### DETAILED DESCRIPTION OF EXAMPLE EMBODIMENTS

### Overview

An example method for performance monitoring and troubleshooting in a storage area network environment is provided and includes receiving, at a network element in the SAN, a plurality of frames of an exchange between an initiator and a target in the SAN, identifying a beginning frame and an ending frame of the exchange in the plurality of frames, copying (e.g., replicating, duplicating, reproducing, etc.) the beginning frame and an ending frame of the exchange to a network processor (e.g., programmable microprocessor) in the network element, extracting (e.g., pulling out, parsing and mining, taking out, etc.), by the network processor, values of a portion of fields in respective headers of the beginning frame and the ending frame, and calculating, by the network processor, a normalized exchange completion time (ECT) based on the values.

As used herein, the term “network element” is meant to encompass SAN switches, computers, network appliances, servers, routers, gateways, bridges, load balancers, firewalls, processors, modules, or any other suitable device, component, element, or object operable to exchange information in a SAN network environment. Moreover, the network elements may include any suitable hardware, software, components, modules, interfaces, or objects that facilitate the operations thereof. This may be inclusive of appropriate algorithms and communication protocols that allow for the effective exchange of data or information. As used herein, the term “initiator” is meant to encompass any network element that initiates (e.g., starts, begins, creates, etc.) a communication session in the network; examples include computing devices such as servers, laptops, smartphones, etc. The term “target” is meant to encompass any network element that receives communication from the initiator and is the intended final destination of such communication; examples include storage devices in the network.

### EXAMPLE EMBODIMENTS

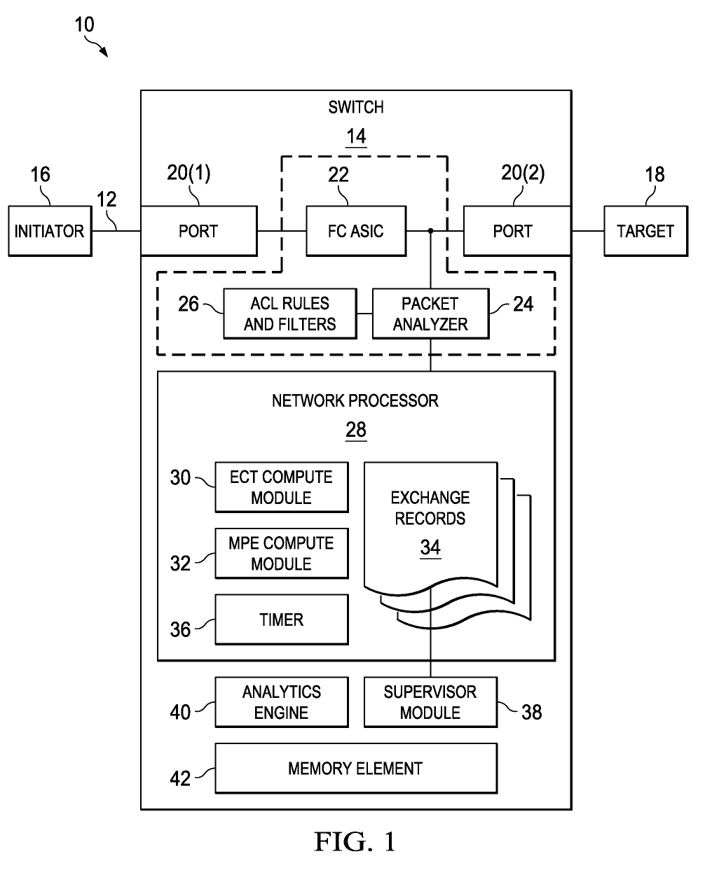

Turning to FIG. 1, FIG. 1 is a simplified block diagram illustrating a communication system 10 for performance monitoring and troubleshooting in a storage area network environment in accordance with one example embodiment. FIG. 1 illustrates a storage area network (SAN) 12 comprising a switch 14 facilitating communication between an initiator 16 and a target 18 in SAN 12. Switch 14 includes a plurality of ports, for example, ports 20(1) and 20(2). A fixed function Fibre-Channel (FC) application specific integrated circuit (ASIC) 22 facilitates switching operations within switch 14. A packet analyzer 24 may sniff frames traversing switch 14 and apply access control list (ACL) rules and filters 26 to copy some of the frames to a network processor 28. In various embodiments, packet analyzer 24 and ACL rules and filters 26 may be implemented in FC ASIC 22. Unlike the non-programmable FC ASIC 22, network processor 28 comprises a programmable microprocessor. In some embodiments, network processor 28 may be optimized for processing network data packets and SAN frames. Specifically, network processor 28 may be configured to handle tasks such as header parsing, pattern matching, bit-field manipulation, table look-ups, packet modification, and data movement.

In various embodiments, network processor 28 may be configured to compute and analyze flow performance parameters such as maximum pending exchanges (MPE) and exchange completion time (ECT), for example, using an appropriate ECT compute module 30 and MPE compute module 32. Exchange records 34 comprising flow details may be stored in network processor 28. A timer 36 may facilitate various timing operations of network processor 28. A supervisor module 38 may periodically extract exchange records 34 for further higher level analysis, for example, by an analytics engine 40. A memory element 42 may represent a totality of all memory in switch 14. Note that in various embodiments, switch 14 may include a plurality of line cards with associated ports, each line card including a separate FC ASIC 22 and network processor 28. The multiple line cards may be managed by a single supervisor module 38 in switch 14.

For purposes of illustrating the techniques of communication system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Fibre Channel (FC) is a high speed serial interface technology that supports several higher layer protocols including Small Computer System Interface (SCSI) and Internet Protocol (IP). FC is a gigabit speed networking technology primarily used in SANs. SANs include servers and storage (SAN devices being called nodes) interconnected via a network of SAN switches using FC protocol for transport of frames. The servers host applications that eventually initiate read and write operations (also called input/output (IO) operations) of data towards the storage. Nodes work within the provided FC topology to communicate with all other nodes. Before any IO operations can be executed, the nodes login to the SAN (e.g., through fabric login (FLOGI) operations) and then to each other (e.g., through port login (PLOGI) operations).

The data involved in IO operations originate as Information Units (IU) passed from an application to the transport protocol. The IUs are packaged into frames for transport in the underlying FC network. In a general sense, a frame is an indivisible IU that may contain data to record on disc or control information such as a SCSI command. Each frame comprises a string of transmission words containing data bytes.

Every frame is prefixed by a start-of-field (SOF) delimiter and suffixed by an end-of-field (EOF) delimiter. All frames also include a 24 bytes long frame header in addition to a payload (e.g., which may be optional, but normally present, with size and contents determined by the frame type). The header is used to control link operation and device protocol transfers, and to detect missing frames or frames that are out of order. Various fields and subfields in the frame header can carry meta-data (e.g., data in addition to payload data, for transmitting protocol specific information). For example, frame header subfields in a F_CTL field are used to identify a beginning, middle, and end of each frame sequence. In another example, each SCSI Command or a task management request includes a FCP_DL field, indicative of the maximum number of all bytes to be transferred to the application client buffer in appropriate payloads by the SCSI command. The FCP_DL field contains the exact number of data bytes to be transferred in the IO operation.

One or more frames form a sequence and multiple such sequences comprise an exchange. The IO operations in the SAN involves one or more exchanges, with each exchange assigned a unique Exchange Identification number (OXID) carried in the frame header. Exchanges are an additional layer that control operations across the FC topology, providing a control environment for transfer of information.

In a typical READ operation, the first sequence is a SCSI READ_CMD command from the server (initiator) to storage (target). The first sequence is followed by a series of SCSI data sequences from storage to server and a last SCSI status sequence from storage to server. The entire set of READ operation sequences form one READ exchange. A typical WRITE operation is also similar, but in the opposite direction (e.g., from storage to server) with an additional TRANSFER READY sequence, completed in one WRITE exchange. At a high level, all data IO operations between the server and the storage can be considered as a series of exchanges over a period of time.

In the past, SANs were traditionally small networks with few switches and devices and the SAN administrators' troubleshooting role was restricted to device level analysis using tools provided by server and/or storage vendors (e.g., EMC Ionix Control Center™, HDS Tuning Manager™, etc.). In contrast, current data center SANs involve a large network of FC switches that interconnect servers to storage. With servers becoming increasingly virtualized (e.g., virtual machines (VMs)) and/or mobile (e.g., migrating between servers) and storage capacity requirement increasing exponentially, there is an explosion of devices that login into the data center SAN. The increase in number of devices in the SAN also increases the number of ports, switches and tiers in the network.

Larger networks involve additional complexity of management and troubleshooting attributed to slow performance of the SAN. In addition to complex troubleshooting of heterogeneous set of devices from different vendors, the networking in large scale SANs include multi-tier switches that may have to be analyzed and debugged for SAN performance issues. One common problem faced by administrators is determining the root cause of application slowness suspected to arise in the SAN. The effort can involve identifying various traffic flows from the application in the SAN, segregating misbehaving flows and eventually identifying the misbehaving devices, links (e.g., edge ports/ISLs), or switches in the SAN. Because the exchange is the fundamental building block of all IO traffic in the SAN, identifying slow exchanges can be important to isolate misbehaving flows of the SAN.

The true performance of the SAN can be measured by tracking an Exchange Completion Time (ECT) of all flows in the SAN. ECT is a measure of how long it takes to complete a full exchange. Flows in the SAN can either be transaction based or backup based, with each type exhibiting different behavior with respect to ECT. Hence, a base-lining of ECT for each type of flow is required. By base-lining typical ECT for various active flows in the SAN from historical data, any deviation of the ECT from the baseline can be considered as a potential misbehaving flow. Given such a misbehaving flow the SID, DID, LUN, ISL ports, edge ports, switch hops in the path, etc. can be analyzed further to determine the root cause of anomalous ECT behavior.

Another flow parameter of interest is the Maximum Pending Exchanges (MPE). MPE is the maximum number of outstanding exchanges at a given point of time for a storage device. MPE can help in determining a “queue-depth” setting on the storage devices for maximum application performance. Flow analytics based on ECT and MPE can be useful to identify bottlenecks and tune network performance in the SAN. There are currently no mechanisms that can calculate the ECT and MPE within a switch in the SAN.

Virtual Instruments (VI) has a solution called Virtual Wisdom® that helps in monitoring ECT and MPE of flows in the SAN using a combination of hardware and software external to the SAN switch. Virtual Wisdom is a network disruptive solution that requires re-cabling to insert hardware taps between the storage and the SAN switch. The taps send copies of all FC frames towards specialized hardware that calculate ECT and MPE of various flows by looking at all the frames. The calculated ECT and MPE are presented to a user using Virtual Wisdom software.

Communication system 10 is configured to address these issues (among others) to offer a system and method for performance monitoring and troubleshooting in a storage area network environment. According to various embodiments, switch 14 receives a plurality of frames of an exchange between initiator 16 and target 18 in SAN 12. Packet analyzer 24 in switch 14 may identify a beginning frame and an ending frame of the exchange in the plurality of frames. In various embodiments, packet SPAN functionality of packet analyzer 24 may be used to setup ACL rules/filters 26 to match on specific frame header fields and redirect (e.g., copy) frames that match the rules to network processor 28 on switch 14.

In various embodiments, ACL rules and filters 26 for packet analyzer 24 may be programmed on edge ports (e.g., 20(2)) connected to targets (e.g., 18) to SPAN frames that have the exchange bit set in the FC header's FCTL bits of the first and last frames of the exchange. In some embodiments, because the first and last frames of the exchange may be traversing different directions of the edge ports (e.g., 20(2)), ACL rules and filters 26 may be programmed in both ingress and egress directions of the edge ports (e.g., 20(2)).

Network processor 28 of switch 14 may extract values of a portion of fields in respective headers of the beginning frame and the ending frame and copy the values into exchange records 34 in network processor 28. Exchange records 34 may be indexed by several flow parameters in network processor 28's memory. For example, a “READ” SCSI command spanned from port 20(2) may result in a flow record entry created with various parameters such as {port, source identifier (SID), destination identifier (DID), logical unit number (LUN), originator exchange identifier (OxID), SCSI_CMD, Start-Time, End-Time, Size} extracted from frame headers.

Network processor 28 may calculate a normalized ECT based on the values stored in exchange records 34. In various embodiments, network processor 28 may start timer 36 when the beginning frame is identified, and stop timer 36 when the ending frame is identified. For example, after the last data is read out from target 18, a Status SCSI command may be sent out by target 18, and may comprise the last frame of the exchange on the ingress direction of storage port 20(2). The frame may be spanned to network processor 28 and may complete the flow record with the exchange end-time. ECT may be calculated as a time elapsed between starting and stopping timer 36. By calculating the total time taken and normalizing it against the size of the exchange, the ECT of the flow can be derived. A baseline ECT maintained for the flow may be compared with the current ECT (e.g., most recent ECT calculated) and the baseline updated or the current ECT red-flagged as a deviation (e.g., the calculated ECT may be flagged appropriately if a deviation is observed from the baseline ECT). A “WRITE” SCSI operation also follows a similar procedure.

Because exchange sizes can be variable, normalization of the ECT values can accommodate variability in exchange sizes, for example, taking the size of data in the exchange into consideration. Normalization as used herein refers to adjusting ECT values measured on different scales corresponding to different exchange sizes to a notionally common scale independent of the exchange sizes. Merely for example purposes, and not as a limitation, assume that a 1 MB read exchange (e.g., reading 1 MB data stored in target 18) can take 1 millisecond (ECT=1 millisecond), whereas a 1 GB read (e.g., reading 1 GB data stored in target 18) can take 1000 milliseconds (ECT=1000 milliseconds). Therefore, the un-normalized ECT can be meaningless without taking the data size into consideration. For example, if the normalized ECT of exchange 1 is 100 milliseconds, and the normalized ECT of exchange 2 is 1000 milliseconds, a problem with exchange 2 may be deduced. The normalized value of ECT of the flow is first base-lined and then used for comparison. To calculate the size of each exchange, the data length field (e.g., FCP_DL) in the frame header of the read and write commands can be used. The data length field may specify a count of the maximum number of bytes to be read or written to an application buffer. The first frame in the exchange of an input/output operation typically includes the FCP_DL information in the frame header.

In some embodiments, switch 14 may receive frames of a plurality of exchanges between various initiators and targets in SAN 12. Note that switch 14 may comprise numerous ports of various speeds switching FC frames that are part of different exchanges, using one or more high speed custom FC ASIC 22. Switch 14 may collect a plurality of exchange records 34 corresponding to the different exchanges in SAN 12, with each exchange record comprising values extracted from the corresponding exchange. Network processor 28 may calculate the MPE for target 18 based on the plurality of exchange records 34 associated with target 18. By calculating the number of flow records at network processor 28 that are outstanding (e.g., incomplete) for target 18, the MPE of target 18 can be deduced. Each flow record in exchange records 34 may have an inactivity timer associated therewith, for example, so that flows that are dormant for long periods may be flushed out from network processor 28's memory.

In various embodiments, a software application, such as analytics engine 40, executing on supervisor module 38 or elsewhere (e.g., in a separate network element) may periodically extract exchange records 34 from network processor 28's memory (e.g., before they are deleted) for consolidation at the flow level and for presentation to a SAN administrator (or other user).

In various embodiments, network processor 28 can store and calculate the ECT and MPE for all the flows of the frames directed towards it using its own compute resources. Because the speed of the link (e.g., 10 Gbps) connecting FC ASIC 22 to network processor 28 cannot handle substantially all frames (e.g., up to 32 Gbps×48 ports) entering FC ASIC 22, packet analyzer 24 can serve to reduce the volume of live traffic from FC ASIC 22 flowing towards network processor 28. For example, only certain SCSI command frames required for identifying flows and calculating ECT may be copied to network processor 28. Other SCSI data frames forming the bulk of typical exchanges need not be copied. Also, as the frame headers can be sufficient to identify a particular exchange, fields beyond the FC and SCSI headers can be truncated before copying the frame to network processor 28. Note that in some embodiments where the volume of traffic passing through FC ASIC 22 is not large, ECT compute module and/or MPE compute module may execute in FC ASIC 22, rather than in network processor 28.

In various embodiments, SAN IO flow performance parameters such as ECT and MPE can facilitate troubleshooting issues attributed to slowness of SANs. The on-switch implementation according to embodiments of communication system 10 to measure SAN performance parameters can eliminate hooking up third-party appliances and software tools to monitor SAN network elements and provide a single point of monitoring and troubleshooting of SAN 12. Embodiments of communication system 10 can facilitate flow level visibility for troubleshooting “application slowness” issues in SAN 12. No additional hardware need be inserted into SAN 12 to calculate flow level performance parameters such as ECT and MPE of IO operations.

In addition, in various embodiments, drastic reduction in frame copies may be achieved. The amount of traffic tapped for analysis may be miniscule compared to the live traffic flowing through switch 14, for example, because ACL rules copy out certain frames of interest and further strip everything other than portions of the frame headers in the copied frames. The on-switch implementation according to embodiments of communication system 10 can reduce cost by eliminating third-party hardware and solution integration costs. Further reduction of power consumption, rack space, optics etc. can result in additional savings. Integration with existing software management tools (e.g., Cisco® Data Center Network Manager (DCNM)) can provide a single point of monitoring and troubleshooting for the SAN administrator.

Various embodiments of communication system 10 can facilitate a single data collection point for analysis. After identifying potential problematic flows from baseline ECT values on switch 14, other on-switch analytic data such as interface level statistics, switch buffer usage, etc. can be used to further troubleshoot and narrow down root-causes of any detected or suspected problems. The procedure can be automated considerably using a software analytics engine, such as analytics engine 40 running on switch 14. Embodiments of communication system 10 can be used by SAN administrators to monitor, tune and troubleshoot performance issues in SAN 12 from switch 14 itself without a third party tool such as Virtual Wisdom™.

Note that in various embodiments, additional analysis of statistics collected by FC ASIC 22, and/or exchange records 34 can facilitate troubleshooting various issues, for example, cyclic redundancy check (CRC) errors on ports caused by cable, SFP, or interference issues; running out of B2B credits frequently caused by link under-provisioning, congestion etc.; loss of synchronization, and signal and link failure on switch port connected to initiator 16 caused by HBA failure or server reboot; frequent login or logout caused by protocol or operational issues between devices; low link utilization indicating a need for consolidation, or high link utilization indicating a need for higher bandwidth; optimal queue depth setting at initiator 16 or target 18 from the calculated MPE; Class 3 discards caused by switch 14 dropping frames from configuration or routing bugs; aborts from signaling error, protocol timeouts, etc.; frequent SCSI BAD STATUS indicating problems with target 18; inventory of SAN including total ports, total ports with traffic, total HBA ports, total storage ports, port speeds, etc. for reclaiming or consolidating ports for CAPEX savings; etc. In various embodiments, a portion of the analysis, for example, calculation of optimal queue depth setting at initiator 16 or target 18 from the calculated MPE may be performed by network processor 28.

Turning to the infrastructure of communication system 10, the network topology can include any number of initiators, targets, servers, hardware accelerators, virtual machines, switches (including distributed virtual switches), routers, and other nodes inter-connected to form a large and complex network. Network 12 represents a series of points or nodes of interconnected communication paths for receiving and transmitting packets and/or frames of information that are delivered to communication system 10. A node may be any electronic device, printer, hard disk drive, client, server, peer, service, application, or other object capable of sending, receiving, or forwarding information over communications channels in a network, for example, using FC and other such protocols. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Network 12 offers a communicative interface between targets (e.g., storage devices) 18 and/or initiators (e.g., hosts) 16, and may be any local area network (LAN), wireless local area network (WLAN), metropolitan area network (MAN), Intranet, Extranet, WAN, virtual private network (VPN), or any other appropriate architecture or system that facilitates communications in a network environment and can provide lossless service, for example, similar to (or according to) FCoE protocols. Network 12 may implement any suitable communication protocol for transmitting and receiving data packets within communication system 10. The architecture of the present disclosure may include a configuration capable of TCP/IP, FC, Fibre Channel over Ethernet (FCoE), and/or other communications for the electronic transmission or reception FC frames in a network. The architecture of the present disclosure may also operate in conjunction with any suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 1 is simplified for ease of illustration.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, switch 14 may comprise a Cisco® MDS™ series multilayer SAN switch. In some embodiments, switch 14 may be to provide line-rate ports based on a purpose-built “switch-on-a-chip” FC ASIC 22 with high performance, high density, and enterprise-class availability. The number of ports may be variable, for example, from 24 to 32 ports. In some embodiments, switch 14 may offer non-blocking architecture, with all ports operating at line rate concurrently.

In some embodiments, switch 14 may match switch-port performance to requirements of connected devices. For example, target-optimized ports may be configured to meet bandwidth demands of high-performance storage devices, servers, and Inter-Switch Links (ISLs). Switch 14 may be configured to include hot-swappable, Small Form-Factor Pluggable (SFP), LC interfaces. Individual ports can be configured with either short- or long-wavelength SFPs for connectivity up to 500 m and 10 km, respectively. The 10-Gbps ports support a range of optics for connection to switch 14 using 10-Gbps ISL connectivity. Multiple switches can also be stacked to cost effectively offer increased port densities.

In some embodiments, network processor 28 may be included in a service card plugged into switch 14. In other embodiments, network processor 28 may be inbuilt in a line card with a direct connection to FC ASIC 22. In some embodiments, the direct connection between network processor 28 and FC ASIC 22 can comprise a 10G XFI or 2.5G SGMII link (Ethernet). In yet other embodiments, network processor 28 may be incorporated with FC ASIC 22 in a single semiconductor chip. In various embodiments, ECT compute module 30 and MPE compute module 32 comprises applications that are executed by network processor 28 in switch 14. Note that an ‘application’ as used herein this Specification, can be inclusive of an executable file comprising instructions that can be understood and processed on a computer, and may further include library modules loaded during execution, object files, system files, hardware logic, software logic, or any other executable modules.

In various embodiments, packet analyzer 24 comprises a network analyzer, protocol analyzer or packet sniffer, including a computer program or a piece of computer hardware that can intercept and log traffic passing through switch 14. As frames flow across switch 14, packet analyzer 24 captures each frame and, as needed, decodes the frame's raw data, showing values of various fields in the frame, and analyzes its content according to appropriate ACL rules and filters 26. ACL rules and filters 26 comprises one or more rules and filters for analyzing frames by packet analyzer 24.

In various embodiments, FC ASIC 22 comprises an ASIC that can build and maintain filter tables, also known as content addressable memory tables for switching between ports 20(1) and 20(2) (among other ports). Analytics engine 40 and supervisor module 38 may comprise applications executing in switch 14 or another network element coupled to switch 14. In some embodiments, supervisor module 38 may periodically extract data from network processor 28 and aggregate suitably. In some embodiments, software executing on supervisor module 38 can connect over a ½.5G GMII link to network processor 28.

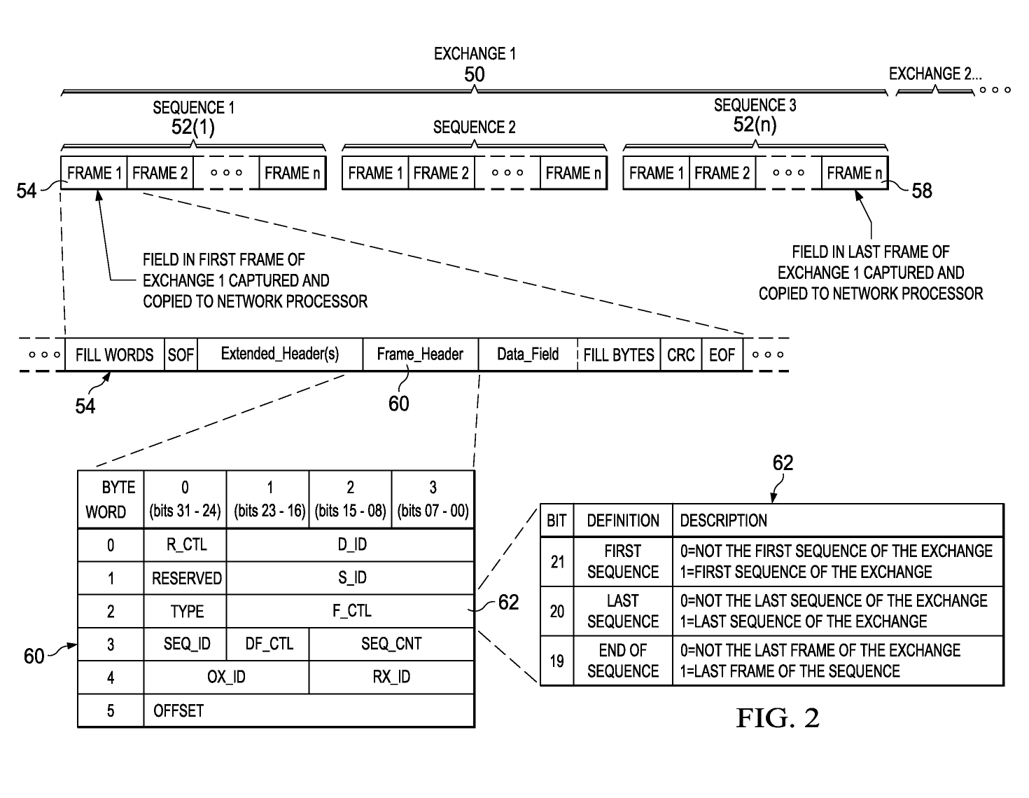

Turning to FIG. 2, FIG. 2 is a simplified block diagram illustrating example details of an embodiment of communication system 10. An example exchange 50 comprises a plurality of sequences 52(1)-52(n). Each sequence 52(i) comprises one or more frames. A first frame 54 of exchange 50 and a last frame 58 of exchange 50 may be identified by packet analyzer 22 and selected values copied to network processor 28. For example, frame 54 may include a frame header 60, which may include a F_CTL field 62. A value of 1 in bit 21 of F_CTL field 62 indicates that sequence 52(1) is a first one of exchange 50. All frames in sequence 52(1) may have a value of 1 in bit 21 of F_CTL field 62. On the other hand, all frames in last sequence 52(n) of exchange 50 may have a value of 0 in bit 21 of F_CTL field 62 and a value of 1 in bit 20 of F_CTL field 62. In addition, the last frame of any sequence, for example, frame 58, has a value of 1 in bit 19 of F_CTL field 62.

Thus, packet analyzer 22 may analyze bits 19-21 of F_CTL field 62 of each frame between ports 20(1) and 20(2) in switch 14. A first frame of exchange 50 having values {0,0,1} in bits 19-21, respectively may be copied to network processor 28. Another frame of exchange 50 having values {1,1,0} in bits 19-21 respectively, representing the last frame of exchange 50 may also be copied to network processor 28.

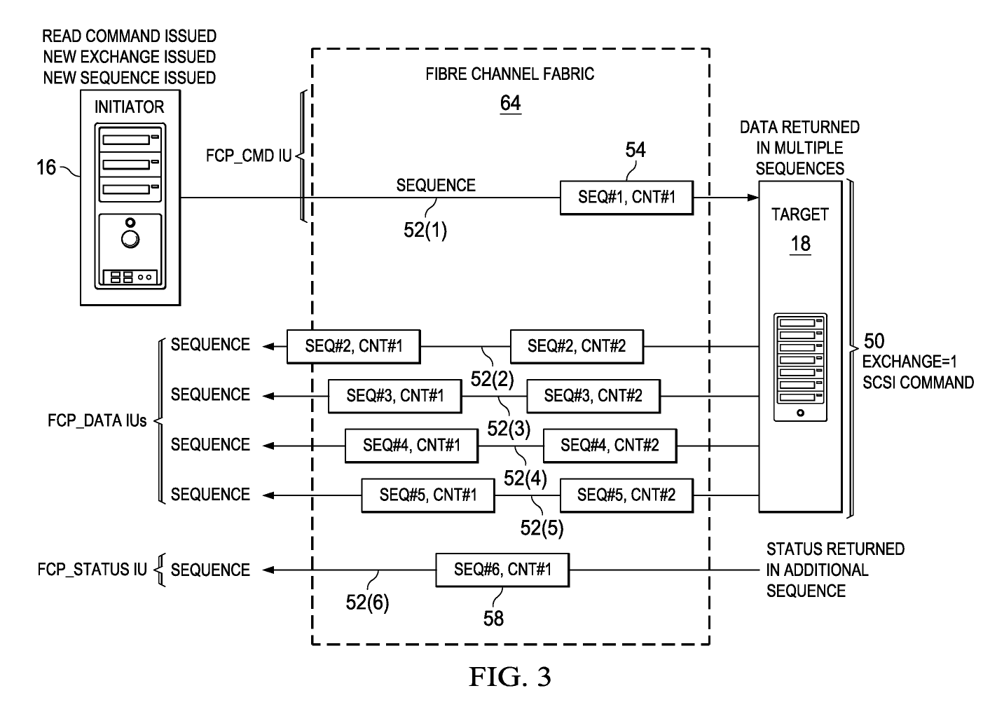

Turning to FIG. 3, FIG. 3 is a simplified block diagram illustrating example details of an embodiment of communication system 10. Example exchange 50 may comprise a READ operation initiated by a READ command at initiator 16 in frame 54 of sequence 52(1) and sent to target 18 over FC fabric 64. FC fabric 64 may comprise one or more switches 14. In an example embodiment, FC fabric 64 may comprise a totality of all switches and other network elements in SAN 12 between initiator 16 and target 18. In other embodiments, FC fabric 64 may comprise a single switch in SAN 12 between initiator 16 and target 18.

Target 18 may deliver the requested data to initiator 16 in a series of sequences, for example, sequences 52(2)-52(5) comprising FC_DATA IUs. Target 18 may complete exchange 50 by sending a last frame 58 in sequence 52(6) to initiator 16. Packet analyzer 22 in FC fabric 64 may capture and copy frames 54 and 58 comprising the first and last frame of exchange 50 for example, for computing ECT of exchange 50 and MPE of target 18.

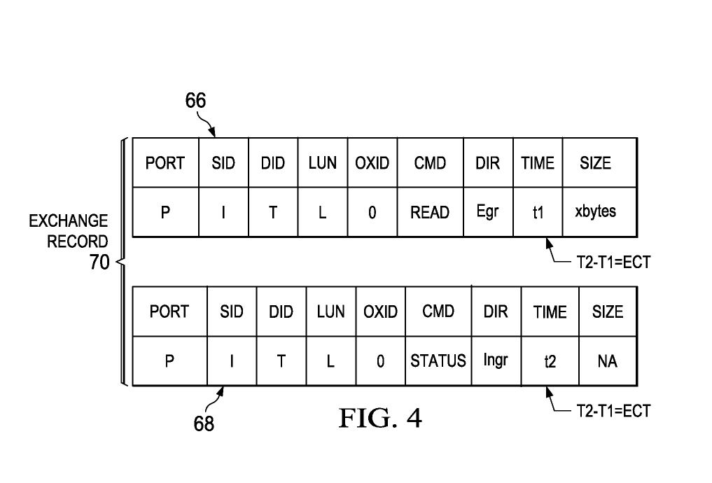

Turning to FIG. 4, FIG. 4 is a simplified block diagram illustrating example details of an embodiment of communication system 10. An example READ command may be received on egress switch port 20(2) of target 18. The Exchange Originator bit may be set in F_CTL field 62, indicating a first frame of the exchange. Data size of READ command may be present in FCP_DL field of the frame header. An example flow record entry 66 may be created to include the port number, source ID, destination ID, LUN, exchange ID, command type (e.g., READ, WRITE, STATUS), direction of traffic (e.g., ingress, egress), time (e.g., start of timer, stop of timer) and size (e.g., from FCP_DL field).

After the last data read out, target 18 may send a STATUS command on ingress port of target 18 with an OK/CHECK condition, with a last sequence of exchange bit set in F_CTL field 62. Another example flow record entry 68 may be created to include the port number, source ID, destination ID, LUN number, exchange ID, command type, direction, time and size. Flow record entries 66 and 68 may together comprise one exchange record 70. The difference between times T2 and T1, representing the stop and start of timer 36, respectively, can indicate the ECT. Normalizing may be achieved by dividing the computed ECT with the size of the data transfer (e.g., in flow record entry 66). In various embodiments, the number of flow record entries 66 (corresponding to exchange origination) associated with a particular target 18 that do not have matching entries 68 (corresponding to the last data read out) may indicate the MPE associated with target 18.

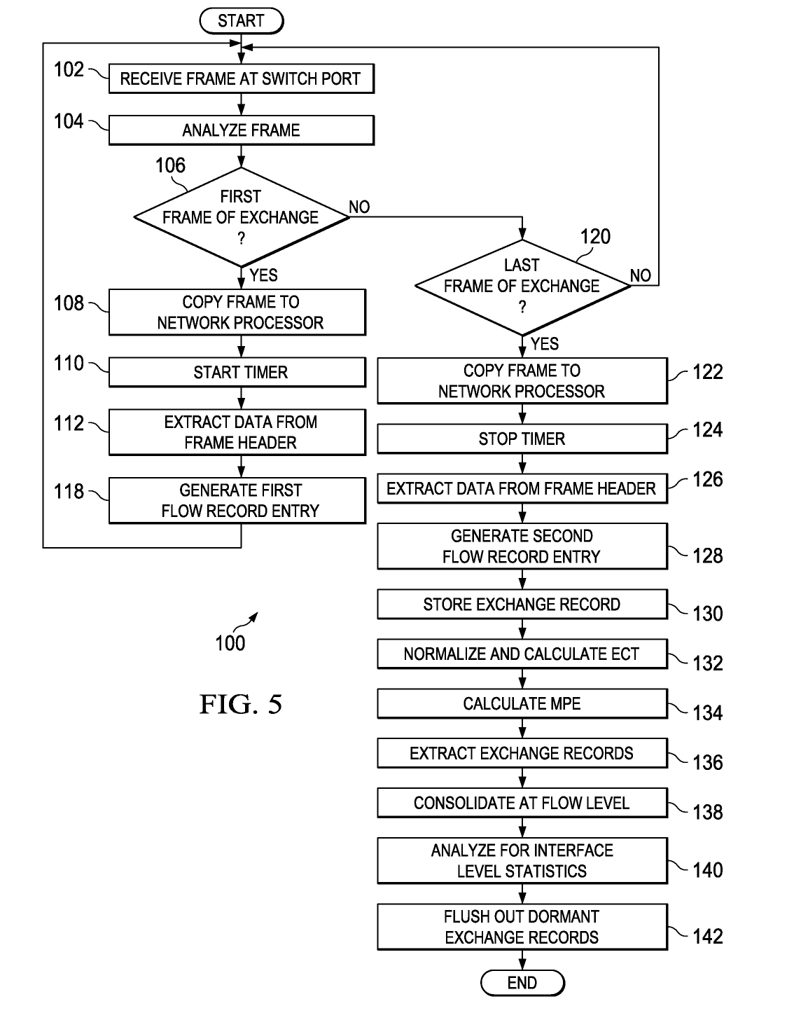

Turning to FIG. 5, FIG. 5 is a simplified flow diagram illustrating example operations 100 that may be associated with embodiments of communication system 10. At 102, switch 14 may receive a frame at port 20(1) from initiator 16. FC ASIC 22 may switch the frame to port 20(2) towards target 18. At 104, packet analyzer 24 may analyze frame at port 20(2). A determination may be made at 106 whether the frame is a first frame of the exchange. If the frame is a first frame of the exchange, at 108, the frame may be copied to network processor 28. At 110, timer 36 of network processor 28 may be started. At 112, data may be extracted from the frame's header. The extracted data may include meta-data such as the port, source ID, destination ID, LUN number, exchange ID, command type (e.g., READ, WRITE, STATUS), direction (e.g., ingress, egress), time (e.g., start of timer, stop of timer) and size (e.g., from FCP_DL field) of data to be exchanged. At 118, a first flow record entry comprising the extracted data may be generated. The operations may revert to 102.

Turning back to 106, if the frame is not a first one of the exchange, at 120, a determination may be made if the frame is a last one of the exchange. If the frame is not a last frame of the exchange, the operations may revert to 102. On the other hand, if the frame is a last one of the exchange, at 122, the frame may be copied to network processor 28. At 124, timer 36 of network processor 28 may be stopped. At 126, data may be extracted from the frame's header. At 128, a second flow record entry may be generated.

At 130, the exchange record comprising the first flow record entry generated at 118 and the second flow record entry generated at 128 may be stored in network processor 28's memory. At 132, ECT may be normalized and computed, for example, by taking into consideration the size of the exchange in bytes. At 134, the MPE for target 18 may be computed, for example, by identifying exchanges that have not yet terminated as of the time of calculation. Note that MPE may be calculated from a plurality of exchange records, some of which may be incomplete (e.g., may not include the second flow record entry). At 136, exchange records 34 may be extracted (e.g., by supervisor module 28). At 138, the information in exchange records 34 may be consolidated at a flow level. At 140, the information in exchange records 34 may be analyzed for interface level statistics and further troubleshooting. At 142, dormant exchange records (e.g., exchange records that have no associated activity (e.g., computations) for a preconfigured time interval) may be flushed, for example, upon expiry of a predetermined time period, as implemented on a timer (e.g., timer 36).

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In example implementations, at least some portions of the activities outlined herein may be implemented in software in, for example, switch 14. In some embodiments, one or more of these features may be implemented in hardware, provided external to these elements, or consolidated in any appropriate manner to achieve the intended functionality. The various components (e.g., packet analyzer 22, network processor 28) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, switch 14 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 42) can store data used for the operations described herein. This includes the memory element being able to store instructions (e.g., software, logic, code, etc.) in non-transitory media, such that the instructions are executed to carry out the activities described in this Specification. A processor can execute any type of instructions associated with the data to achieve the operations detailed herein in this Specification. In one example, processors (e.g., network processor 28) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method executed by a network element in a storage area network (SAN), comprising:
receiving a plurality of frames of an exchange between an initiator and a target in the SAN;
identifying a beginning frame and an ending frame of the exchange in the plurality of frames;
copying the beginning frame and an ending frame of the exchange to a network processor in the network element;
extracting, by the network processor, values of a portion of fields in respective headers of the beginning frame and the ending frame; and
calculating, by the network processor, a normalized exchange completion time (ECT) based on the values.

2. The method of claim 1, further comprising:
collecting a plurality of exchange records corresponding to different exchanges involving the target in the SAN, wherein each exchange record comprises values extracted from corresponding exchanges;
calculating a maximum pending exchange (MPE) of the target based on the plurality of exchange records.

3. The method of claim 1, wherein the calculating comprises:
starting a timer when the beginning frame is identified;
stopping the timer when the ending frame is identified; and
calculating the ECT as a time elapsed between starting and stopping the timer.

4. The method of claim 3, wherein the calculating further comprises:
determining a size of data in the exchange based on the values; and
normalizing the calculated ECT based in the size of data.

5. The method of claim 1, wherein the beginning frame and the ending frame of the exchange are identified by a packet analyzer based on preconfigured access control lists (ACL) rules and filters.

6. The method of claim 5, wherein the ACL rules and filters are programmed on edge ports of the network element connected to the target.

7. The method of claim 1, wherein the extracted values correspond to at least the following fields: port number, source identifier (SID), destination identifier (DID), logical unit number (LUN), command type, exchange identifier (OXID), direction of traffic, and size of the exchange.

8. The method of claim 1, further comprising:
generating a first flow record entry with values extracted from the first frame of the exchange;
generating a second flow record entry with values extracted from the second frame of the exchange; and
generating an exchange record from the first flow record entry and the second flow record entry.

9. The method of claim 1, wherein the network processor is inbuilt into a line card with a direct connection to a Fibre Channel (FC) Application Specific Integrated Circuit (ASIC) that performs switching operations within the network element.

10. The method of claim 1, further comprising:
computing a baseline ECT based on past calculations of ECT;
comparing the calculated ECT with the baseline ECT; and
flagging the calculated ECT if a deviation is observed from the baseline ECT.

11. Non-transitory tangible media that includes instructions for execution, which when executed by a processor of a network element in a SAN, is operable to perform operations comprising:
receiving a plurality of frames of an exchange between an initiator and a target in the SAN;
identifying a beginning frame and an ending frame of the exchange in the plurality of frames;
copying the beginning frame and an ending frame of the exchange to a network processor in the network element;
extracting, by the network processor, values of a portion of fields in respective headers of the beginning frame and the ending frame; and
calculating, by the network processor, a normalized ECT based on the values.

12. The media of claim 11, wherein the calculating further comprises:
starting a timer when the beginning frame is identified;
stopping the timer when the ending frame is identified; and
calculating the ECT as a time elapsed between starting and stopping the timer.

13. The media of claim 12, wherein the calculating further comprises:
determining a size of data in the exchange based on the values; and
normalizing the calculated ECT based in the size of data.

14. The media of claim 11, wherein the beginning frame and the ending frame of the exchange are identified by a packet analyzer based on preconfigured ACL rules and filters.

15. The media of claim 11, wherein the extracted values correspond to at least the following fields: port number, SID, DID, LUN, command type, OXID, direction of traffic, and size of the exchange.

16. An apparatus in a SAN, comprising:
a memory element for storing data; and
a network processor, wherein the network processor executes instructions associated with the data, wherein the network processor and the memory element cooperate, such that the apparatus is configured for:
receiving a plurality of frames of an exchange between an initiator and a target in the SAN;
identifying a beginning frame and an ending frame of the exchange in the plurality of frames;
copying the beginning frame and an ending frame of the exchange to the network processor in the network element;
extracting values of a portion of fields in respective headers of the beginning frame and the ending frame; and
calculating a normalized ECT based on the values.

17. The apparatus of claim 16, wherein the calculating further comprises:
starting a timer when the beginning frame is identified;
stopping the timer when the ending frame is identified; and
calculating the ECT as a time elapsed between starting and stopping the timer.

18. The apparatus of claim 17, wherein the calculating further comprises:
determining a size of data in the exchange based on the values; and
normalizing the calculated ECT based in the size of data.

19. The apparatus of claim 16, wherein the beginning frame and the ending frame of the exchange are identified by a packet analyzer based on preconfigured ACL rules and filters.

20. The apparatus of claim 16, wherein the extracted values correspond to at least the following fields: port number, SID, DID, LUN, command type, OXID, direction of traffic, and size of the exchange.
